(19) United States
(12) Patent Application Publication
(10) Pub. No.: US 2013/0216235 A1
(43) Pub. Date: Aug. 22, 2013

(54) TRANSMISSION SYSTEM AND ELECTRONIC EQUIPMENT

(71) Applicants: Yoshihisa Ishida, Nara-Shi (JP); Naru Yasuda, Uji-shi (JP); Hayami Hosokawa, Tsuzuki-gun (JP)

(72) Inventors: Yoshihisa Ishida, Nara-Shi (JP); Naru Yasuda, Uji-shi (JP); Hayami Hosokawa, Tsuzuki-gun (JP)

(73) Assignee: OMRON Corporation, Kyoto (JP)

(21) Appl. No.: 13/818,600

(22) PCT Filed: Mar. 16, 2011
(86) PCT No.: PCT/JP2011/056225

§ 371 Date: May 7, 2013

(30) Foreign Application Priority Data
Sep. 17, 2010 (JP) 2010-209394

(51) Int. Cl. H04B 10/2507

(52) U.S. Cl. CPC H04B 10/2507
USPC 398/130; 398/141

(57) ABSTRACT

A data transmission system is provided with a transmission unit, a receiving unit, transmission paths, and a delay unit. The delay unit is disposed on a transmission path along which a high-speed signal is transmitted, and delays the transmission of the high-speed signal with respect to a low-speed signal. When the high-speed signal is transmitted from a section b2 to c along the transmission path, a delay time of Δt occurs with respect to when the high-speed signal is transmitted from a section a to b1 along the transmission path. In other words, the phase of the high-speed signal transmitted from section b2 to c is shifted with respect to the phase of the high-speed signal transmitted from section a to b1. Consequently, a time interval in which an EMI peak value occurs can be reduced, thereby enabling the probability of an EMI peak value occurring to be reduced.

### BACKGROUND OF THE INVENTION

1. Technical Field

The present invention relates to a transmission system and an electronic device equipped therewith, particularly to a technology for a countermeasure to electromagnetic interference (EMI) of the electronic device.

2. Background Art

An operating frequency of an information processing device typified by a mobile phone is enhanced year by year with the progress of high integration or high functionality of a semiconductor element. Therefore, there is increasing use of a serial differential interface that can transmit a signal at high speed. For example, spread of interfaces using an MIPI D-PHY layer such as MIPI (Mobile Industry Processor Interface) DSI and CSI2 accelerates. In such interfaces, through the same transmission line, differential transmission of high-speed signals, such as an image data signal, is performed with a low voltage and non-differential transmission of low-speed signals, such as a control signal, is performed with low power consumption.

On the other hand, with enhancing operating frequency of an information processing device, an electromagnetic noise (hereinafter also referred to as EMI) generated from an inside of the information processing device, particularly a data transmission line becomes a problem. The EMI becomes a noise component to a radio signal received by an antenna of a mobile terminal according to electric field intensity of the EMI. For example, the EMI causes a sound skip during a phone call of the mobile phone and a block noise on a screen of a mobile television set or a television telephone.

In order to control the EMI generated from the data transmission line, for example, Japanese Unexamined Patent Publication No. 11-53081 (Patent Document 1) and Japanese Unexamined Patent Publication No. 2004-165941 (Patent Document 2) disclose a method for providing a transmission line for a reversed-phase signal in addition to a data transmission line. Because the methods disclosed in Patent Documents 1 and 2 are methods for bringing the two transmission lines close to each other, the EMI cannot completely be prevented in principle. Additionally, the EMI is also generated by various causes, such as a board environment, a variation in production, and time-related degradation. Accordingly, it is difficult to estimate the generation of the EMI at a design stage. Therefore, it is necessary to implement an additional countermeasure such as a shield as means for suppressing the generated EMI on an EMI generation source and devices, such as a wireless communication device, which are vulnerable to the EMI (for example, Japanese Unexamined Patent Publication No. 2005-217294 (see Patent Document 3)).

For example, in the case that the shield is placed on a display surface, possibly visibility cannot be ensured. In a folding mobile terminal, sometimes wiring is disposed in a hinge to connect the boards to each other. In the case that the shield is placed on the wiring, possibly a bending property of the wiring cannot be ensured. Accordingly, unfortunately the device vulnerable to the EMI cannot be placed around a region where the shield is hardly placed.

In the interface based on the MIPI D-PHY, the transmission is frequently generated between at least two voltage states such that the low-speed signal is transmitted with the high voltage while the high-speed signal is transmitted with the low voltage. However, unfortunately the EMI including the harmonic component is easily generated during the transition between the voltage states.

An object of at least one embodiment of the present invention is to decrease the probability of occurrence of the peak value of the EMI in the serial interface, which takes at least two different voltage values and transmits the signals at different transmission speeds with the voltage values.

### SUMMARY

In accordance with one aspect of at least one embodiment of the present invention, a transmission system comprises a transmission unit, a receiving unit, a transmission line, and a delay unit. The transmission unit transmits a first signal having a first voltage value at a first transmission speed, and transmits a second signal having a second voltage value larger than the first voltage value at a second transmission speed lower than the first transmission speed. The receiving unit receives the first and second signals. The transmission line is configured to perform serial transmission of the first signal, and the first and second signals are transmitted through the transmission line. The delay unit is provided on the transmission line to delay the transmission of the first signal with respect to the second signal.

The serial interface, in which the first signal (the high-speed signal) and the second signal (the low-speed signal) having the different voltage values are transmitted and the serial transmission of the first signal (the high-speed signal) is performed, is constructed according to the configuration. The delay unit delays the transmission of the first signal (the high-speed signal) with respect to the second signal (the low-speed signal). The high-speed signal input from the transmission unit to the delay unit through the transmission line differs from the high-speed signal output from the delay unit through the transmission line in the phase, so that the probability of occurrence of the peak value of the EMI can be decreased. When the probability of occurrence of the peak value of the EMI is increased, the EMI has the influence on the electronic device, which results in a problem in that, for example, a noise component is included in a radio signal received by the antenna of the electronic device. Therefore, for example, there is a possibility of generating the sound skip during the phone call of the mobile phone or a block noise on the screen of a mobile television set or a television telephone. According to the configuration, because the probability of occurrence of the peak value of the EMI can be decreased, the frequency of causing the problem can be decreased.

There is no particular limitation to the first and second signals. For example, the first signal may be an image data signal displaying an image on a display, a clock, or the both. One or plural channels may transmit the signals. For example, the transmission line for the first signal is a differential transmission line. However, the transmission line for the first signal is not limited to the differential transmission line.

For example, the second signal is a signal in which real-time transmission is required. In the case that the first signal includes the image data signal, for example, the second signal is a signal controlling the display of the image on the display. A demand for the real-time transmission of the second signal can be satisfied because the second signal dose not delay.

The first voltage value and the second voltage value are not limited to specific values as long as the second voltage value is larger than the first voltage value as described above. The first transmission speed and the second transmission speed are not limited to specific values as long as the second transmission speed is lower than the first transmission speed (the first transmission speed is higher than the second transmission speed).

Preferably the first signal transmitted from the transmission unit includes an invalid signal to processing based on the first signal, and a valid signal to the processing. The delay unit delays the valid signal of the invalid signal and the valid signal.

According to the configuration, a time necessary for the transmission unit to transmit the invalid signal can be shortened. Therefore, because the time necessary for the transmission unit to transmit the first signal can be shortened, the power consumption of the transmission unit can be reduced. The power consumption of the transmission system can be reduced by reducing the power consumption of the transmission unit.

There is no particular limitation to the processing based on the first signal. For example, the receiving unit may fix a speed of the first signal while receiving the invalid signal. Therefore, when the input of the invalid signal to the receiving unit is started, the receiving unit can surely receive the valid signal.

Until starting the output of the valid signal, the delay unit may generate the same signal as the invalid signal transmitted from the transmission unit. There is no particular limitation to a kind of the invalid signal.

Preferably the transmission line comprises: a first transmission line through which the first and second signals transmitted from the transmission unit are commonly transmitted; a separator that separates the first and second signals transmitted through the first transmission line; a coupler that couples the first and second signals separated by the separator; a second transmission line through which the first and second signals coupled by the coupler are transmitted from the coupler to the receiving unit; and third and fourth transmission lines that are provided in parallel between the separator and the coupler, the first and second signals being transmitted through the third and fourth transmission lines, respectively. The delay unit is provided on the third transmission line.

According to the configuration, both the first signal and the second signal are transmitted in the first transmission line and the second transmission line. In the transmission lines, the state of the signal voltage transitions from the first voltage state to the second voltage state. The noise including the harmonic component is easily generated when the transition of the voltage state is generated. Because the delay unit delays the transmission of the first signal, timing at which the voltage state changes in the second transmission line is delayed compared with timing at which the voltage state changes in the first transmission line. Therefore, timing at which the noise is generated from the second transmission line is delayed compared with timing at which the noise is generated from the first transmission line. Each of the transmission line between the transmission unit and the delay unit and the transmission line between the delay unit and the receiving unit is shorter than the transmission line between the transmission unit and the receiving unit in the case that the delay unit is not provided. Therefore, the intensity of the EMI generated from the transmission line between the transmission unit and the delay unit decreases according to a ratio of a length of the transmission line and a length of the transmission line between the transmission unit and the receiving unit in the case that the delay unit is not provided. For the same reason, the intensity of the EMI generated from the transmission line between the delay unit and the receiving unit also decreases. Not only the timing at which the EMI is generated is deviated, but also the intensity of the EMI decreases, so that the probability of occurrence of the peak value of the EMI can be decreased.

Preferably the transmission line comprises: a first transmission line through which the first signal is transmitted; and a second transmission line through which the second signal is transmitted. The first transmission line includes an optical wiring. The transmission system further includes: a light emitting element that generates an optical signal transmitted through the optical wiring; a driving circuit that, in response to the first signal, drives the light emitting element to generate the optical signal in the light emitting element; a light receiving element that converts the optical signal transmitted through the optical wiring into an electric signal; and an amplifier circuit that amplifies the electric signal output from the light receiving element. The light emitting element, the driving circuit, the light receiving element, and the amplifier circuit are provided on the first transmission line. The delay unit is provided in at least one of a preceding position of the driving circuit on the first transmission line and a subsequent position of the amplifier circuit on the third transmission line.

Preferably the third transmission line includes an optical wiring. The transmission system further comprises: a light emitting element that generates an optical signal transmitted through the optical wiring; a driving circuit that, in response to the first signal, drives the light emitting element to generate the optical signal in the light emitting element; a light receiving element that converts the optical signal transmitted through the optical wiring into an electric signal; and an amplifier circuit that amplifies the electric signal output from the light receiving element. The light emitting element, the driving circuit, the light receiving element, and the amplifier circuit are provided on the third transmission line. The delay unit is provided in at least one of a preceding position of the driving circuit on the first transmission line and a subsequent position of the amplifier circuit on the third transmission line.

According to the configuration, the optical wiring is included in the transmission line through which the first signal (the high-speed signal) is transmitted. The EMI is not generated from the optical wiring, so that the probability of occurrence of the peak value of the EMI can further be decreased.

Preferably the first signal transmitted from the transmission unit includes an invalid signal to processing based on the first signal and a valid signal to the processing. The delay unit delays the valid signal of the invalid signal and the valid signal. A sum period of a transmission period of the invalid signal transmitted from the transmission unit and a time for which the valid signal is delayed by the delay unit is set so as to be longer than a rising time from a time when the first signal is input to the driving circuit to a time when the light emitting element starts up.

According to the configuration, the rising times of the light emitting element and the driving circuit can be used as part of the delay time in order to delay the transmission of the valid signal. Therefore, the transmission time of the first signal can be shortened; the average power consumption can be reduced during the operation of the transmission system. As described above, there is no particular limitation to the kind of the “invalid signal”.

The “rising time” means a time from when the signal is input to the driving circuit to when the stable signal is transmitted from the light emitting element. The time to when the stable signal is transmitted means a time that an error of the signal from the light emitting element is not generated thereafter.

Preferably each of the transmission unit and the receiving unit includes a plurality of channels that transmit a plurality of first signals. The transmission system further comprises: a serializer circuit that converts the plurality of first signals transmitted from the plurality of channels of the transmission unit into a serial signal; and a deserializer circuit that converts the serial signal into the plurality of first signals received by the plurality of channels of the receiving unit.

According to the configuration, in the transmission line through which the first signal (the high-speed signal) is transmitted, the EMI can be reduced or the generation of the EMI can substantially be eliminated. Accordingly, the probability of occurrence of the peak value of the EMI can be decreased.

Preferably the light emitting element and the driving circuit are mounted on a transmission module. The light receiving element and the amplifier circuit are mounted on a receiving module. The optical wiring is connected between the transmission module and the receiving module. At least one of the transmission module and the receiving module includes the delay unit.

Preferably the light emitting element, the driving circuit, and the serializer circuit are mounted on a transmission module. The light receiving element, the amplifier circuit, and the deserializer circuit are mounted on a receiving module. The optical wiring is connected between the transmission module and the receiving module. At least one of the transmission module and the receiving module includes the delay unit.

Preferably the light emitting element, the driving circuit, and the separator are mounted on a transmission module. The light receiving element, the amplifier circuit, and the coupler are mounted on a receiving module. The optical wiring is connected between the transmission module and the receiving module. At least one of the transmission module and the receiving module includes the delay unit.

Preferably the light emitting element, the driving circuit, and the serializer circuit are mounted on a transmission module. The light receiving element, the amplifier circuit, and the deserializer circuit are mounted on a receiving module. The optical wiring is connected between the transmission module and the receiving module. At least one of the transmission module and the receiving module includes the delay unit.

Preferably the light emitting element, the driving circuit, the separator, and the serializer circuit are mounted on a transmission module. The light receiving element, the amplifier circuit, the coupler, and the deserializer circuit are mounted on a receiving module. The optical wiring is connected between the transmission module and the receiving module. At least one of the transmission module and the receiving module includes the delay unit.

According to the configuration, the optical wiring module including the transmission module, the optical wiring, and the receiving module can have the function of delaying the high-speed signal.

Preferably the first signal is an image data signal that is used in display processing performed by a display device. The second signal is a control signal that is used to control the display processing performed by the display device.

According to the configuration, the transmission system can be used as an interface for the image display of the display device.

Preferably the first signal is an image data signal corresponding to an image captured by a camera.

According to the configuration, the transmission system can be used as an interface, which transmits the image data output from the camera, for the image display of the display device.

Preferably the first signal is a signal including data that is transmitted and received by wireless communication.

According to the configuration, the transmission system can be used as an interface that transmits the wirelessly-received data and an interface that transmits the wirelessly-transmitted data.

In accordance with another aspect of at least one embodiment of the present invention, an electronic device includes the transmission system.

Preferably the electronic device is a mobile phone.

According to the configuration, in the case that the EMI is generated in the electronic device, the probability of occurrence of the peak value of the EMI can be decreased. In the case that the electronic device is a mobile phone, the frequency of generating a sound skip during phone call can be decreased. In the case that the electronic device is a mobile television set or a television telephone, the frequency of generating a block noise on a screen can be decreased.

According to at least one embodiment of the present invention, the probability of occurrence of the peak value of the EMI can be decreased in the serial interface, which takes at least two different voltage values and transmits the signals at different transmission speeds with the voltage values.

### BRIEF DESCRIPTION OF THE DRAWINGS

FIG. 1 is a view illustrating a configuration of a transmission system according to a first embodiment of the present invention.

FIG. 2 is a timing chart illustrating high-speed signal transmission and low-speed signal transmission, which are performed by the transmission system of the first embodiment.

FIG. 3 is a view illustrating an FIFO memory.

FIG. 4 is a view illustrating an influence of EMI on an electronic device equipped with the transmission system of the first embodiment.

FIG. 5 is a view illustrating the EMI at a spot d when a delay unit 4 is eliminated from the configuration in FIG. 4.

FIG. 6 is a view illustrating an effect of the transmission system of the first embodiment.

FIG. 7 is a view illustrating the EMI that is generated by a periodically changing high-speed signal when a delay unit 4 is eliminated from the configuration in FIG. 4.

FIG. 8 is a view illustrating an effect of the transmission system of the first embodiment.

FIG. 9 is a view illustrating PLLs included in a transmission unit and a receiving unit.

FIG. 10 is a timing chart illustrating high-speed signal transmission and low-speed signal transmission, which are performed by a transmission system according to a second embodiment.

FIG. 11 is a view illustrating a relationship between a transmission frequency band of a high-speed signal and a frequency band of the PLL when a delay unit is eliminated from the configuration in FIG. 9.

FIGS. 12(A) and 12(B) are schematic diagrams illustrating an effect of the second embodiment. FIG. 12(A) illustrates timing at which a transmission unit and a receiving unit transmit signals when the delay unit is not provided in a transmission line of a high-speed signal. FIG. 12(B) illustrates timing at which the transmission unit and the receiving unit transmit signals when the delay unit is provided in the transmission line of the high-speed signal (that is, in the case of the second embodiment).

FIG. 13 is a view illustrating a configuration of a transmission system 10A according to a third embodiment.

FIG. 14 is a timing chart illustrating the high-speed signal transmission and the low-speed signal transmission, which are performed by the transmission system of the third embodiment.

FIG. 15 is a view illustrating the influence of EMI on an electronic device equipped with the transmission system of the third embodiment.

FIG. 16 is a view illustrating the EMI at the spot d when the delay unit 4 is eliminated from the configuration in FIG. 15.

FIG. 17 is a view illustrating an effect of the transmission system of the third embodiment.

FIGS. 18(A) and 18(B) are views illustrating a configuration of a transmission system according to a fourth embodiment. FIG. 18(A) is a view illustrating a first example of the configuration of the transmission system of the fourth embodiment. FIG. 18(B) is a view illustrating a second example of the configuration of the transmission system of the fourth embodiment.

FIG. 19 is a timing chart illustrating the high-speed signal transmission and the low-speed signal transmission, which are performed by a transmission system according to a fifth embodiment.

FIGS. 20(A), 20(B) and 20(C) are views illustrating a configuration of a transmission system according to a sixth embodiment. FIG. 20(A) is a view illustrating a first example of the configuration of the transmission system of the sixth embodiment. FIG. 20(B) is a view illustrating a second example of the configuration of the transmission system of the sixth embodiment. FIG. 20(C) is a view illustrating a third example of the configuration of the transmission system of the sixth embodiment.

FIGS. 21(A), 21(B) and 21(C) are views illustrating a configuration of a transmission system according to a seventh embodiment. FIG. 21(A) is a view illustrating a first example of the configuration of the transmission system of the seventh embodiment. FIG. 21(B) is a view illustrating a second example of the configuration of the transmission system of the seventh embodiment. FIG. 21(C) is a view illustrating a third example of the configuration of the transmission system of the seventh embodiment.

FIG. 22 is a view illustrating a first example of the configuration of an electronic device equipped with the transmission system of an embodiment of the present invention.

FIG. 23 is a view illustrating a second example of the configuration of the electronic device equipped with the transmission system of an embodiment of the present invention.

FIGS. 24(A) and 24(B) are views illustrating a third example of the configuration of the electronic device equipped with the transmission system of an embodiment of the present invention. FIG. 24(B) is a view illustrating a fourth example of the configuration of the electronic device equipped with the transmission system of an embodiment of the present invention.

FIG. 25 is a perspective view illustrating a mobile phone that is one of the electronic devices equipped with the transmission system of the present invention when the mobile phone is viewed from a front direction.

FIG. 26 is a perspective view illustrating the mobile phone in FIG. 25 when the mobile phone is viewed from a backside direction.

FIG. 27 is a perspective view illustrating a hinge 101 in FIG. 25 and a peripheral portion thereof.

FIG. 28 is a view illustrating an example of the configuration of an optical wiring module.

### DESCRIPTION OF THE EMBODIMENTS OF THE INVENTION

Hereinafter, embodiments of the present invention will be described in detail with reference to the drawings. In the drawings, the identical or equivalent component is designated by the identical symbol, and the overlapping description is omitted.

### First Embodiment

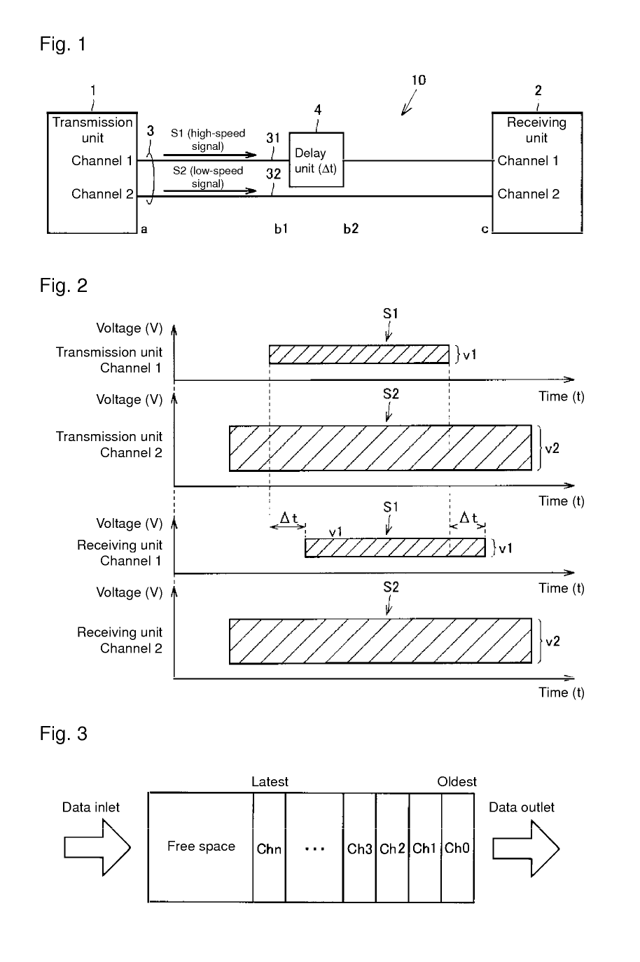

FIG. 1 is a view illustrating a configuration of a transmission system according to a first embodiment of the present invention. Referring to FIG. 1, a transmission system 10 includes a transmission unit 1, a receiving unit 2, a transmission line 3, and a delay unit 4.

The transmission system according to an embodiment of the present invention can be applied to a serial interface, which takes at least two different voltage values and transmits a signal at a different transmission speed with each voltage value.

The transmission unit 1 includes a channel 1 through which a high-speed signal S1 is transmitted and a channel 2 through which a low-speed signal S2 is transmitted. Similarly, the receiving unit 2 includes a channel 1 through which the high-speed signal S1 is transmitted and a channel 2 through which the low-speed signal S2 is transmitted.

The transmission line 3 includes a transmission line 31 through which the high-speed signal S1 is transmitted and a transmission line 32 through which the low-speed signal S2 is transmitted. The delay unit 4 is provided on the transmission line 31 through which the high-speed signal S1 is transmitted, and the delay unit 4 delays the transmission of the high-speed signal S1 with respect to the low-speed signal S2.

In an embodiment of the present invention, there is no particular limitation to a kind of an electric device on which the transmission system is mounted. For example, as described later, the transmission system of each embodiment can be applied to a high-speed-transmission serial interface of a mobile phone. Specifically, the transmission system 10 is mounted on the mobile phone as a serial interface compatible with an MIPI D-PHY standard. For example, a low-amplitude, high-speed signal (the high-speed signal S1) is serial data (image information) transmitted from a processor to a display or a camera to the processor, and a serial clock. On the other hand, for example, a high-amplitude, low-speed signal (the low-speed signal S2) is a control signal.

The transmission system of an embodiment of the present invention may separately include a clock-transmission channel and a data-transmission channel as a high-speed-signal transmission channel. There is no particular limitation to the number of transmission channels as long as the transmission system includes the high-speed-signal transmission channel and the low-speed-signal transmission channel. The transmission line 31 through which the high-speed signal S1 is transmitted may be a differential transmission line.

FIG. 2 is a timing chart illustrating high-speed signal transmission and low-speed signal transmission, which are performed by the transmission system of the first embodiment. Referring to FIGS. 1 and 2, the high-speed signal S1 (having a transmission speed V1) having a signal voltage v1 is transmitted from the channel 1 of the transmission unit 1, and the low-speed signal S2 (having a transmission speed V2) having a signal voltage v2 is transmitted from the channel 2 of the transmission unit 1. A relationship of v1<v2 holds between the voltages v1 and v2, and a relationship of V1>V2 between the transmission speeds V1 and V2.

The high-speed signal S1 output from the channel 1 of the transmission unit 1 is input to the delay unit 4 through the transmission line 31. The delay unit 4 delays the transmission of the high-speed signal S1 by Δt. As a result, the high-speed signal S1 is input to the channel 1 of the receiving unit 2 after the delay by Δt from the transmission of the transmission unit 1.

The low-speed signal S2 output from the channel 2 of the transmission unit 1 is input to the channel 2 of the receiving unit 2 through the transmission line 32. The actual delay is not generated in the transmission of the low-speed signal S2 from the transmission unit 1 to the receiving unit 2.

There is no particular limitation to the configuration of the delay unit 4. For example, the delay unit 4 is constructed by an additional transmission line that is connected to the transmission line 31 to lengthen the transmission line 31. For example, the delay unit 4 may be constructed by a FIFO (First In First Out) memory.

FIG. 3 is a view illustrating the FIFO memory. As illustrated in FIG. 3, the FIFO memory has a pipe-like structure. The data written from an inlet is read from an outlet in a chronological order. The delay time Δt of the high-speed signal S1 can be set by properly setting a read starting accumulation amount of the FIFO memory.

According to the configuration in FIG. 1, a phase of the high-speed signal output from the delay unit 4 can be deviated from a phase of the high-speed signal input to the delay unit 4. Therefore, the probability of occurrence of the peak value of the EMI can be decreased. The peak value of the EMI corresponds to the EMI intensity that generates an influence on an operation of the electronic device equipped with the transmission system. For example, in the case that the electronic device is a mobile phone, the EMI intensity that generates a phone call failure (for example, sound skip) corresponds to the peak value of the EMI.

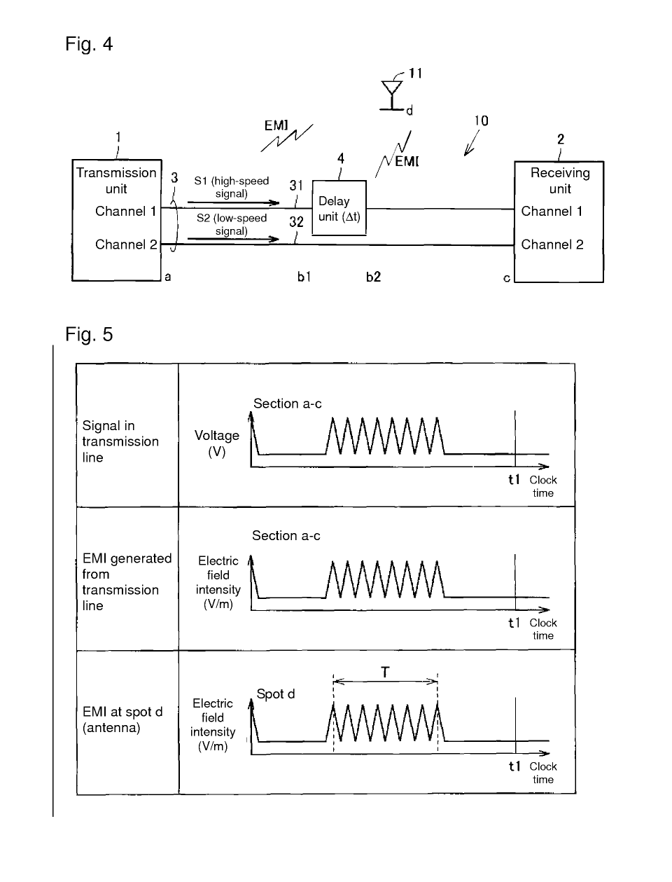

FIG. 4 is a view illustrating an influence of EMI on the electronic device equipped with the transmission system of the first embodiment. Referring to FIG. 4, a section a-c corresponds to a section from the transmission unit 1 to the receiving unit 2. A section a-b1 corresponds to a section from the transmission unit 1 to the delay unit 4. A section b2-c corresponds to a section from the delay unit 4 to the receiving unit 2. A noise (the EMI) is generated from the transmission line 31 when the high-speed signal S1 is transmitted through the transmission line 31. Similarly, a noise (the EMI) is generated from the transmission line 32 when the high-speed signal S1 is transmitted through the transmission line 32. In the case that an antenna 11 is provided at a spot d, possibly the antenna 11 receives the noise generated from the transmission line 31 and the noise generated from the transmission line 32. With increasing intensity of the noise received by the antenna 11 (that is, in the case that the peak value of the EMI emerges), the noise has the large influence on the operation of the electronic device.

FIG. 5 is a view illustrating the EMI at the spot d when the delay unit 4 is eliminated from the configuration in FIG. 4. Referring to FIGS. 4 and 5, in the case that the delay unit 4 is not provided in the transmission line 31, the EMI having the intensity corresponding to the amplitude of the high-speed signal S1 is generated from the transmission line 31 by the high-speed signal S1 transmitted through the transmission line 31 (the section a-c). At the spot d (the antenna 11), the EMI becomes the peak value during a time T. The time T is substantially equal to a time in which the high-speed signal S1 is transmitted through the transmission line 31.

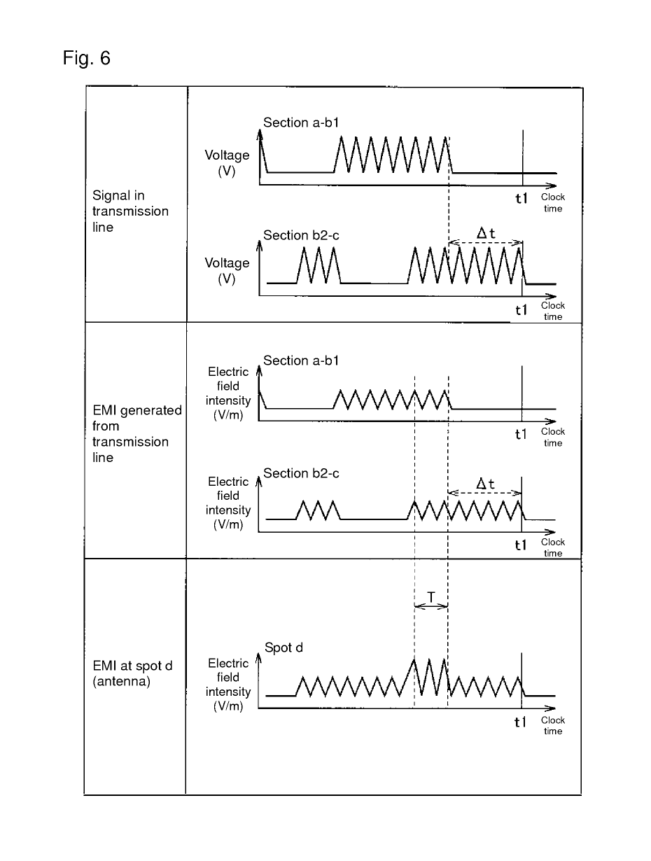

FIG. 6 is a view illustrating an effect of the transmission system of the first embodiment. Referring to FIG. 6, in the case that the high-speed signal is transmitted through the section b2-c in the transmission line 31, the delay time Δt is generated with respect to the case that the high-speed signal is transmitted through the section a-b1 in the transmission line 31. That is, the phase of the high-speed signal transmitted through the section b2-c is deviated from the phase of the high-speed signal transmitted through the section a-b1.

At the spot d (the antenna 11), the EMI generated from the section a-b1 and the EMI generated from the section b2-c overlap each other during the time T. Therefore, during the time T, the intensity of the EMI becomes the peak value at the spot d. In the case in FIG. 5, the peak value of the EMI emerges while the high-speed signal is transmitted through the transmission line 31. On the other hand, according to the first embodiment, because the phase of the EMI generated from the section a-b1 is deviated from the phase of the EMI generated from the section b2-c as illustrated in FIG. 6, a period T during which the peak value of the EMI is generated is shortened compared with the case in FIG. 5. Therefore, the probability of occurrence of the peak value of the EMI can be decreased in the antenna 11.

For example, the delay time Δt is determined in consideration of the transmission speed of the high-speed signal. For example, in the case that the high-speed signal is signals, such as the serial clock, in which H (High) and L (Low) are repeated at a predetermined cycle, the delay time Δt can be determined as follows.

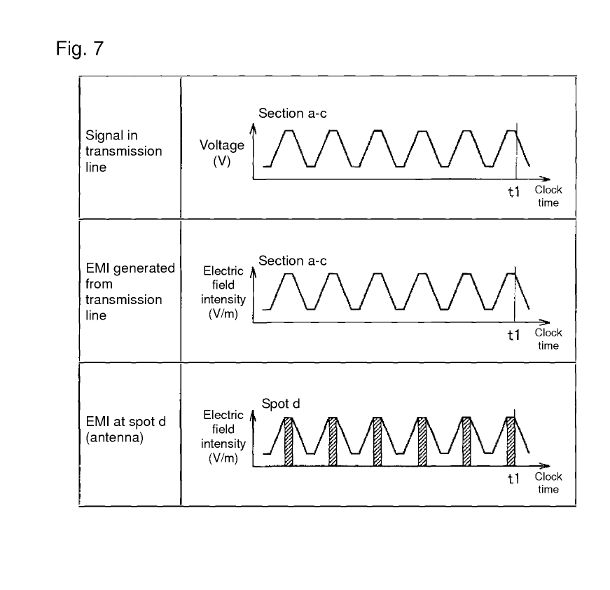

FIG. 7 is a view illustrating the EMI that is generated by a periodically changing high-speed signal when the delay unit 4 is eliminated from the configuration in FIG. 4. Referring to FIGS. 4 and 7, at the spot d (the antenna 11), the peak value of the EMI emerges in each constant cycle.

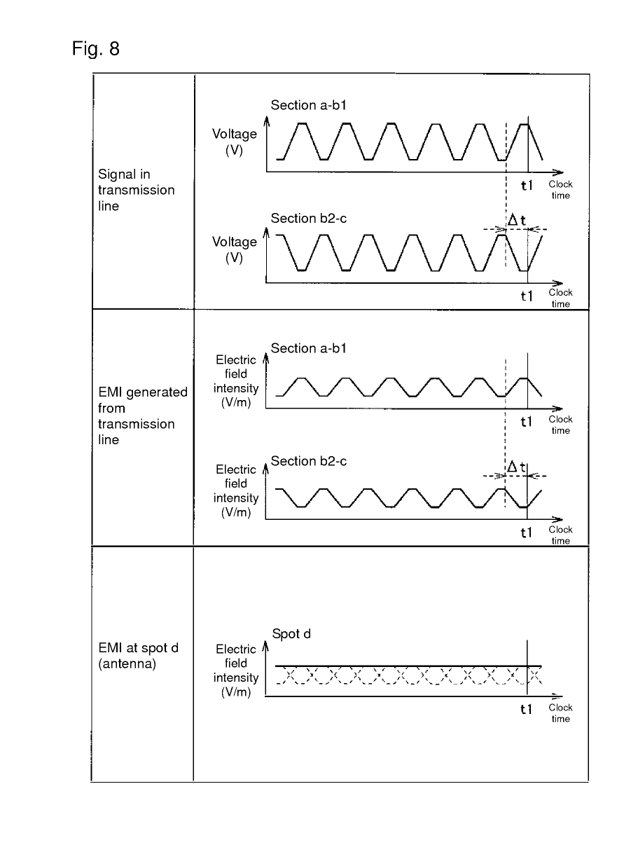

FIG. 8 is a view illustrating the effect of the transmission system of the first embodiment. Referring to FIG. 8, the delay time Δt is set to ½ of the cycle of the high-speed signal. Therefore, the phase of the high-speed signal transmitted through the section b2-c is delayed by a half cycle from the phase of the high-speed signal transmitted through the section a-b1.

In this case, the intensity of the EMI in the antenna 11 becomes a constant value smaller than the peak value. Accordingly, the probability of occurrence of the peak value of the EMI can be decreased to zero in the antenna 11.

As described above, in the first embodiment, the delay unit is provided on the data transmission line through which the high-speed signal is transmitted from the transmission unit 1 to the receiving unit 2. The high-speed signal input to the delay unit differs from the high-speed signal output from the delay unit in the phase, so that the EMI generated in the input-side section (section a-b1) of the delay unit differs from the EMI generated in the output-side section (section b2-c) of the delay unit in the phase. The period in which the pieces of EMI generated from both the section overlap each other at the same spot (for example, the spot d at which the antenna 11 is provided) is shortened, so that the probability of occurrence of the peak value of the EMI can be decreased.

When the probability of occurrence of the peak value of the EMI is increased, the EMI has the influence on the electronic device, which results in a problem in that, for example, a noise component is included in a radio signal received by the antenna of the electronic device. Therefore, for example, there is a possibility of generating the sound skip during the phone call of the mobile phone or a block noise on the screen of a mobile television set or a television telephone. According to the first embodiment, the frequency causing the problems can be decreased because the probability of occurrence of the peak value of the EMI can be decreased.

### Second Embodiment

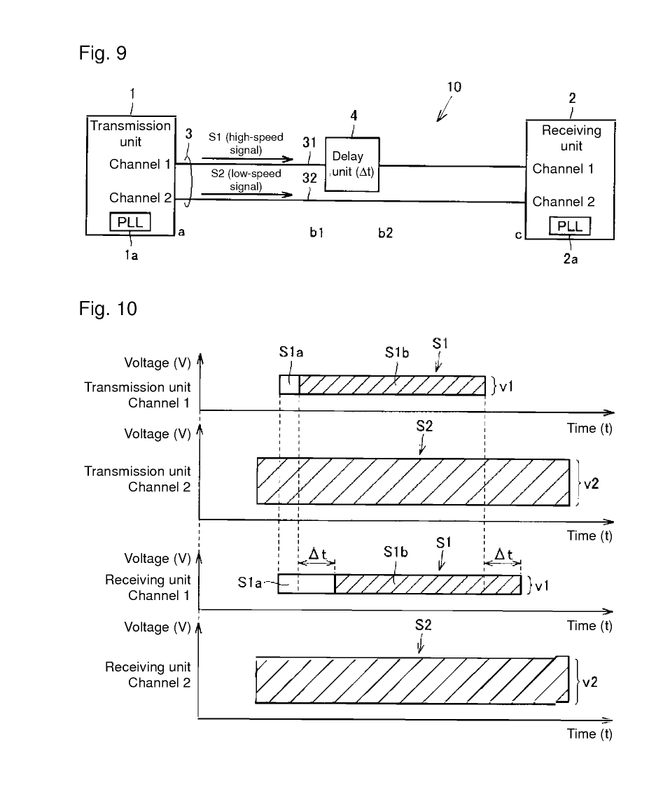

A whole configuration of a transmission system according to a second embodiment is identical to that in FIG. 1. As illustrated in FIG. 9, the transmission unit 1 and the receiving unit 2 include PLL circuits 1a and 2a, respectively. The PLL circuit 1a is used to determine the transmission speed (in a transmission frequency band) of the signal of the transmission unit 1. Similarly the PLL circuit 2a is used to determine the transmission speed of the signal of the receiving unit 2.

In the second embodiment, the high-speed signal includes a valid signal to processing (for example, image display processing) based on the high-speed signal and an invalid signal to the processing. The transmission system of the second embodiment delays only the valid signal of the invalid signal and the valid signal.

FIG. 10 is a timing chart illustrating the high-speed signal transmission and the low-speed signal transmission, which are performed by the transmission system of the second embodiment. Referring to FIG. 10, the high-speed signal S1 includes an invalid signal S1a and a valid signal S1b. There is no particular limitation to the invalid signal S1a. For example, a normally-high-level signal or normally-low-level signal (that is, a DC signal) may be used as the invalid signal S1a. On the other hand, the valid signal S1b is a signal that follows a packet (for example, “00011101”) defined by eight bits.

The delay unit 4 delays the transmission of the valid signal S1b by Δt. Until the delay unit 4 transmits the valid signal S1b, the delay unit 4 may generate the same invalid signal as the invalid signal of the high-speed signal transmitted from the transmission unit 1.

In the serial interface based on the MIPI D-PHY, a standard compatible with plural transmission speeds, such as a whole display mode and partial display mode of a display and a moving image mode and a still image mode of a camera, is adopted for the transmission of high-speed signals, such as pixel data of the display. Therefore, a band (a range from a lower limit to an upper limit of the transmission speed at which the signal can be transmitted) of the transmission speed is widened. On the other hand, in the above serial interface, it is necessary to transmit the invalid high-speed signal during a phase synchronous period of the PLL in order to determine the transmission speed.

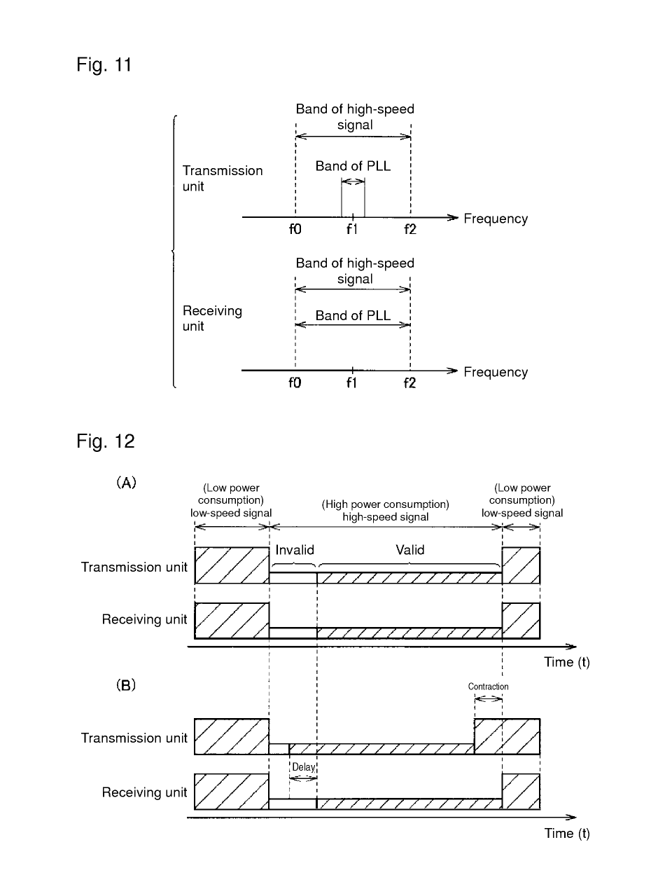

FIG. 11 is a view illustrating a relationship between a transmission frequency band of the high-speed signal and a frequency band of the PLL when the delay unit is eliminated from the configuration in FIG. 9. Referring to FIG. 11, a range of frequencies f0 to f2 is the transmission band of the high-speed signal. The phase synchronous period of the PLL 1a is lengthened with widening transmission band.

The transmission unit 1 can recognize the transmission speed of the high-speed signal before transmitting the high-speed signal. Therefore, the frequency band of the PLL 1a can be narrowed by narrowing the transmission frequency band to the band (in FIG. 1, a specific range including the frequency f1) corresponding to the transmission speed of the high-speed signal. The beginning of the transmission of the valid signal can be set ahead, because a time necessary for the phase synchronization of the PLL 1a can be shortened by narrowing the frequency band of the PLL 1a. Accordingly, average power consumption can be reduced during operation of the transmission system because the transmission time of the high-speed signal can be shortened.

However, the receiving unit 2 cannot detect the transmission speed of the high-speed signal before receiving the high-speed signal. Therefore, the PLL 2a of the receiving unit 2 cannot narrow the frequency band so as to correspond to the transmission speed of the high-speed signal. The frequency band of the PLL 2a of the receiving unit 2 is kept at the band (the range of frequencies f0 to f2) of the high-speed signal, and it is necessary for the receiving unit 2 to receive the invalid high-speed signal for a long time.

Because the frequency band of the PLL 2a of the receiving unit 2 is not narrowed, it is necessary for the transmission unit 1 to continuously transmit the invalid high-speed signal in a period corresponding to a receiving time of the receiving unit. Due to the restriction on the side of the receiving unit 2, the average power consumption of the transmission system is kept high during the operation.

On the other hand, in the second embodiment, the delay unit 4 delays the transmission of the valid signal of the high-speed signal. Therefore, the period during which the transmission unit 1 transmits the invalid signal can be shortened while the period during which the receiving unit 2 receives the invalid signal is not changed.

FIGS. 12(A) and 12(B) are schematic diagrams illustrating the effect of the second embodiment. FIG. 12(A) illustrates timing at which the transmission unit and the receiving unit transmit the signals when the delay unit is not provided in the transmission line of the high-speed signal. In this case, because the transmission unit 1 transmits the invalid high-speed signal for the time corresponding to the receiving time of the receiving unit 2, the transmission time of the high-speed signal cannot be shortened.

FIG. 12(B) illustrates timing at which the transmission unit and the receiving unit transmit the signals when the delay unit is provided in the transmission line of the high-speed signal (that is, in the case of the second embodiment). In the second embodiment, by delaying only the valid high-speed signal, the time for which the transmission unit 1 transmits the invalid high-speed signal can be shortened compared with the time for which the receiving unit 2 receives the invalid high-speed signal. Therefore, the time for which the transmission unit 1 transmits the high-speed signal can be shortened. Therefore, the average power consumption can be reduced during the operation of the transmission system.

As described above, according to the second embodiment, like the first embodiment, the probability of occurrence of the peak value of the EMI can be decreased. Additionally, according to the second embodiment, the average power consumption can be reduced during the operation of the transmission system.

### Third Embodiment

A transmission system according to a third embodiment differs from the transmission system of the first embodiment in the configuration of the transmission line.

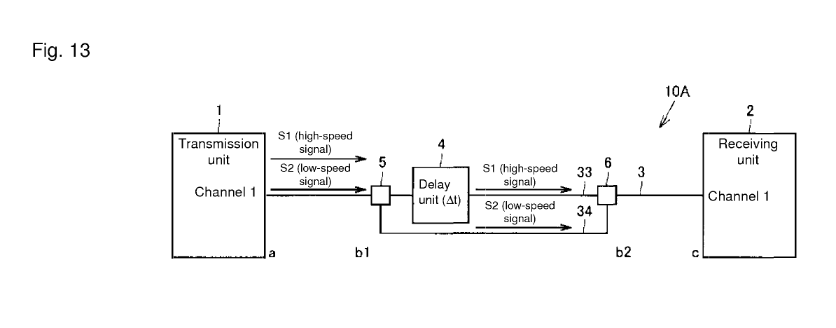

FIG. 13 is a view illustrating a configuration of a transmission system 10A of the third embodiment. Referring to FIGS. 1 and 13, the transmission system 10A differs from the transmission system 10 in that a signal separator 5 and a signal coupler 6 are provided on the transmission line 3. Transmission lines 33 and 34 are provided in parallel between the signal separator 5 and the signal coupler 6. The delay unit 4 is provided on the transmission line 33.

The transmission unit 1 transmits the high-speed signal S1 and the low-speed signal S2 through the transmission line 3 using the same channel (in this case, the channel 1). The signal separator 5 separates the high-speed signal S1 and the low-speed signal S2, which are transmitted from the transmission unit 1 through the transmission line 3. There is no particular limitation to a separation method performed by the signal separator 5. For example, the high-speed signal S1 and the low-speed signal S2 may be separated from each other by comparing an amplitude voltage of the signal to a reference voltage. Alternatively, the signal separator 5 may separate the high-speed signal S1 and the low-speed signal S2 from each other based on the transmission speed of the signal.

The high-speed signal S1 separated by the signal separator 5 is input to the delay unit 4 provided on the transmission line 33. The delay unit 4 delays the transmission of the high-speed signal S1 with respect to the low-speed signal S2.

The high-speed signal S1 output from the delay unit 4 is input to the signal coupler 6 through the transmission line 33. On the other hand, the low-speed signal S2 separated by the signal separator 5 is input to the signal coupler 6 through the transmission line 34. The signal coupler 6 couples the high-speed signal S1 and the low-speed signal S2, which are separated by the signal separator 5. The high-speed signal S1 and the low-speed signal S2, which are coupled by the signal coupler 6, are input to the channel 1 of the receiving unit 2 through the transmission line 3.

As described above, for example, the high-speed signal S1 is the data transmitted from the processor to the display or from the camera to the processor or the clock. On the other hand, for example, the low-speed signal S2 is a control signal in which the real-time transmission is required. Specifically, the low-speed signal S2 is an image display synchronous signal (a horizontal synchronous signal (H-sync) or a vertical synchronous signal (V-sync)) and a display refresh timing notification signal.

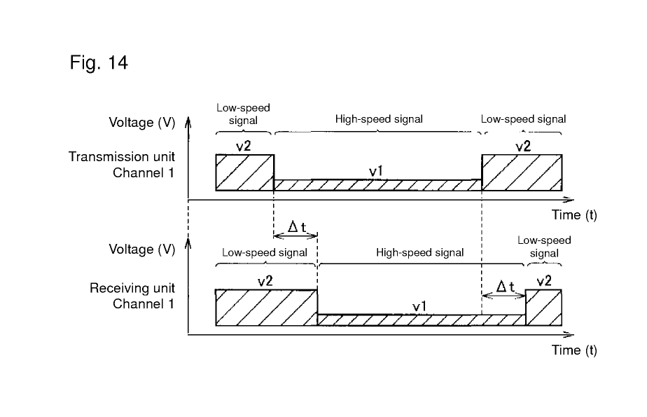

FIG. 14 is a timing chart illustrating the high-speed signal transmission and the low-speed signal transmission, which are performed by the transmission system of the third embodiment. Referring to FIGS. 13 and 14, for example, the low-speed signal S2 (having the transmission speed V2) having the voltage v2 is transmitted from the channel 1 of the transmission unit 1, and then the high-speed signal S1 (having the transmission speed V1) having the voltage v1 is transmitted from the channel 1 of the transmission unit 1. The low-speed signal S2 is again transmitted after the high-speed signal S1. The relationship of v1<v2 holds between the voltages v1 and v2, and the relationship of V1>V2 between the transmission speeds V1 and V2.

The signal separator 5 separates the high-speed signal S1 and the low-speed signal S2 from each other. After the delay unit 4 delays only the transmission of the high-speed signal S1 by Δt, the signal coupler 6 couples the high-speed signal S1 and the low-speed signal S2. In the receiving unit 2, the clock time at which the reception of the high-speed signal S1 is started is deviated by Δt with respect to the clock time at which the transmission unit 1 starts the transmission of the high-speed signal S1. Similarly, in the receiving unit 2, the clock time at which the reception of the high-speed signal S1 is ended is deviated by Δt with respect to the clock time at which the transmission unit 1 ends the transmission of the high-speed signal S1.

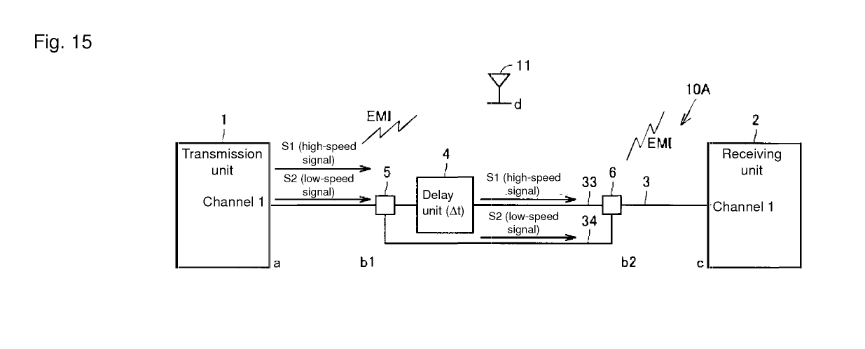

FIG. 15 is a view illustrating the influence of the EMI on the electronic device equipped with the transmission system of the third embodiment. Referring to FIG. 15, the section a-b1 corresponds to the section from the transmission unit 1 to the signal separator 5. The section b2-c corresponds to the section from the signal coupler 6 to the receiving unit 2. Like the configuration in FIG. 4, the antenna 11 is provided at the spot d.

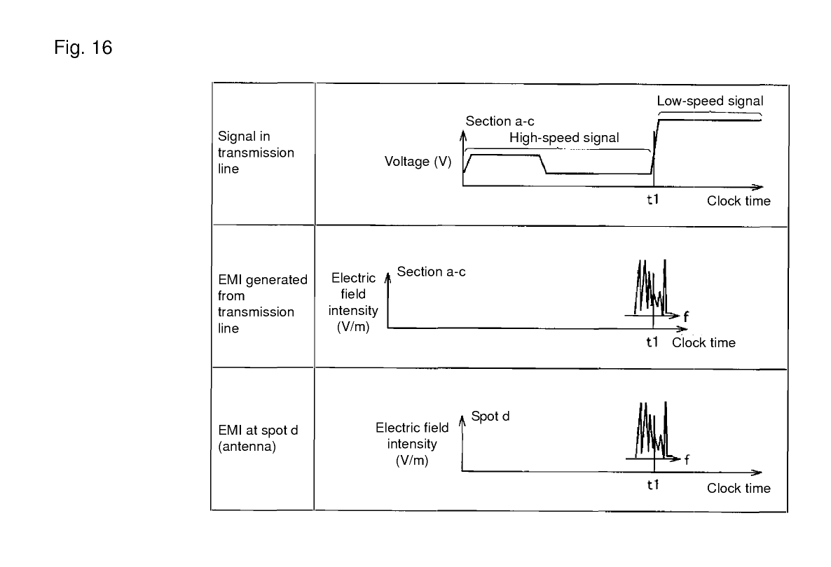

FIG. 16 is a view illustrating the EMI at the spot d when the delay unit 4 is eliminated from the configuration in FIG. 15. Referring to FIGS. 15 and 16, because the signal separator 5 and the signal coupler 6 are not required in the case that the delay unit 4 is not provided in the transmission line, it is assumed that the high-speed signal S1 and the low-speed signal S2 are transmitted through the same transmission line that connects the channel 1 of the transmission unit 1 to the channel 1 of the receiving unit 2. At a clock time t1, the low-speed signal is transmitted subsequent to the high-speed signal, whereby a voltage state at an arbitrary point in the section a-c transitions from a state corresponding to the high-speed signal to a state corresponding to the low-speed signal.

The amplitude voltage of the low-speed signal is larger than the amplitude voltage of the high-speed signal. In this case, the EMI including a harmonic component, which is easily generated at a changing point of the amplitude, is generated. Because both the high-speed signal and the low-speed signal are transmitted in the whole section a-c, the probability of occurrence of the peak value of the EMI is increased at the spot d (the antenna 11).

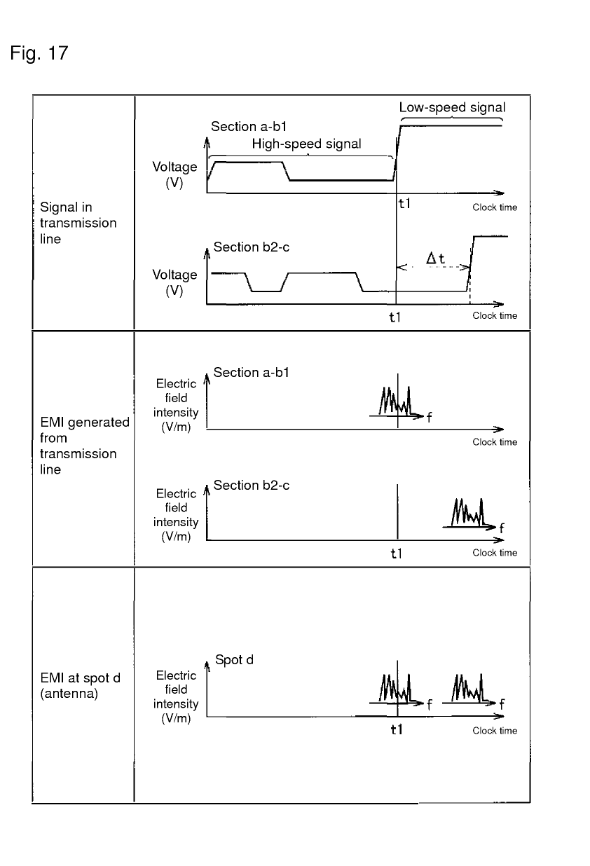

FIG. 17 is a view illustrating the effect of the transmission system of the third embodiment. Referring to FIGS. 15 and 17, in the third embodiment, the section in which both the high-speed signal and the low-speed signal are transmitted is the section a-b1 and the section b2-c. The high-speed signal is delayed in the section b1-b2.

In the section a-b1, at a clock time t, the noise (the EMI) is generated while the voltage state (the amplitude voltage of the signal) largely changes. On the other hand, in the section b2-c, at a clock time delayed by Δt from the clock time t, the noise (the EMI) is generated while the voltage state (the amplitude voltage of the signal) largely changes. Therefore, the antenna 11 receives the EMI from the section a-b1 and the EMI from the section b-c2 at different clock times.

Each of the transmission line between the transmission unit 1 and the delay unit 4 and the transmission line between the delay unit 4 and the receiving unit 2 is shorter than the transmission line between the transmission unit 1 and the receiving unit 2 in the case that the delay unit 4 is not provided. Therefore, the intensity of the EMI generated from the transmission line between the transmission unit 1 and the delay unit 4 is decreased according to a ratio of the length of the transmission line and the length of the transmission line between the transmission unit 1 and the receiving unit 2 in the case that the delay unit 4 is not provided. For the same reason, the intensity of the EMI generated from the transmission line between the delay unit 4 and the receiving unit 2 is also decreased. Not only the time the EMI is generated is deviated, but also the intensity of the EMI is decreased. Therefore, because the probability that the intensity of the EMI received by the antenna reaches the peak value can be decreased, the probability of occurrence of the peak value of the EMI can be decreased.

As described above, according to the third embodiment, the high-speed signal and the low-speed signal are separated from each other, and the transmission of the separated high-speed signal is delayed. Therefore, the probability of occurrence of the peak value of the EMI can be decreased.

### Fourth Embodiment

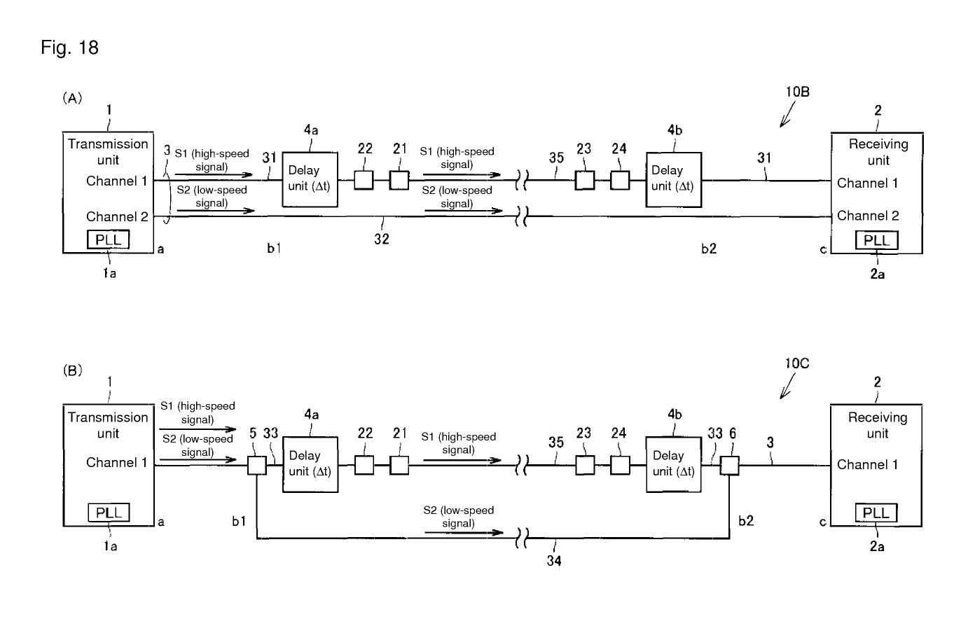

FIGS. 18(A) and 18(B) are views illustrating a configuration of a transmission system according to a fourth embodiment. FIG. 18(A) is a view illustrating a first example of the configuration of the transmission system of the fourth embodiment. FIG. 18(B) is a view illustrating a second example of the configuration of the transmission system of the fourth embodiment.

As illustrated in FIGS. 18(A) and 18(B), in the transmission system (10B and 10C) of the fourth embodiment, an optical wiring 35 is partially included in the transmission line 31 of the high-speed signal S1. A light emitting element 21, a driving circuit 22 that drives the light emitting element 21, a light receiving element 23, and an amplifier circuit 24 are provided on the transmission line 31 according to the optical wiring 35. The transmission system 10B in FIG. 18(A) differs from the transmission system 10 (see FIG. 1) of the first embodiment in this point. Similarly, the transmission system 10C in FIG. 18(B) differs from the transmission system 10A (see FIG. 13) of the third embodiment in this point.

In the configurations in FIGS. 18(A) and 18(B), two delay units (4a and 4b) are provided. The delay unit 4a is provided at a preceding position of the driving circuit 22. On the other hand, the delay unit 4b is provided at a subsequent position of the amplifier circuit 24. Alternatively, the delay unit may be provided at only one of the preceding position of the driving circuit 22 and the subsequent position of the amplifier circuit 24.

The delay unit 4a and the driving circuit 22 may integrally be provided. Similarly, the delay unit 4b and the amplifier circuit 24 may integrally be provided.

The driving circuit 22 drives the light emitting element 21 in response to the high-speed signal S1 input from the delay unit 4a. The light emitting element 21 is driven by the driving circuit 22 to generate an optical signal transmitted through the optical wiring 35. Typically the light emitting element 21 is a semiconductor laser. For example, the light emitting element 21 is a VCSEL (Vertical Cavity-Surface Emitting Laser).

The driving circuit 22 supplies a driving current to the light emitting element 21, and modulates the driving current in response to the high-speed signal input to the driving circuit 22. Therefore, the light emitted from the light emitting element 21 is modulated to generate the optical signal. The optical signal, which is generated by the light emitting element 21 and the driving circuit 22, is input to the light receiving element 23 through the optical wiring 35.

The light receiving element 23 receives the optical signal transmitted through the optical wiring 35, and converts the optical signal into an electric signal. Typically the light receiving element 23 is a photodiode. The amplifier circuit 24 amplifies the electric signal output from the light receiving element 23.

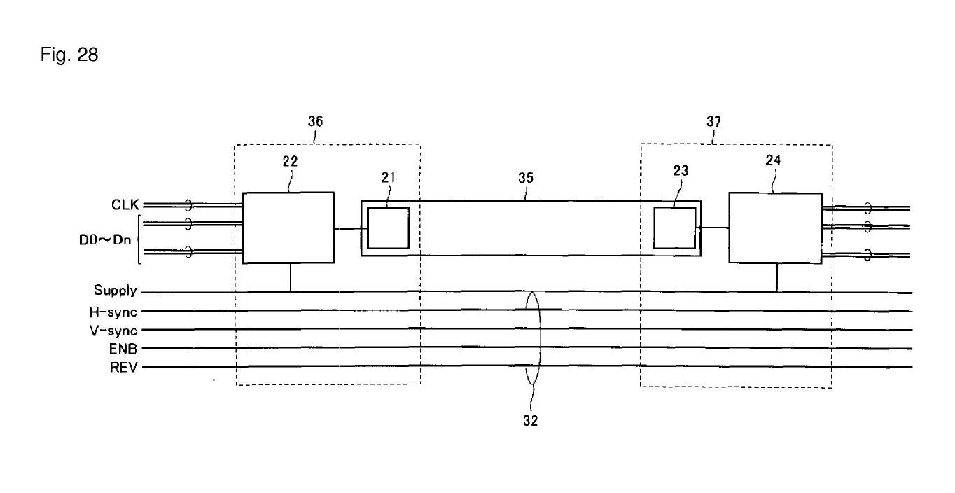

The light emitting element 21, the driving circuit 22, the light receiving element 23, the amplifier circuit 24, and the optical wiring 35 may be mounted as an optical wiring module. FIG. 28 is a view illustrating an example of the configuration of the optical wiring module.

Referring to FIG. 28, the optical wiring module includes an optical transmission unit 36, an optical receiving unit 37, an optical wiring 35, an electric wiring unit (electric signal inputting wiring) connected to the optical transmission unit 36, and an electric wiring unit (electric signal outputting wiring) connected to the optical receiving unit 37.

The optical transmission unit 36 includes the driving circuit 22 and the light emitting element 21. The driving circuit 22 drives the light emitting element 21 in response to the high-speed signal (a clock signal CLK and data signals D0 to Dn are illustrated in FIG. 28) input through the electric wiring unit. The light emitting element 21 emits the light propagating through the optical wiring 35

The optical wiring 35 may be made of glass or resin. Among others, preferably resin materials, such as an acrylic resin, an epoxy resin, a urethane resin, and silicone resin, are used as the optical wiring 35. The optical wiring having sufficient flexibility can be implemented using the resins. The optical wiring has the sufficient flexibility, so that the optical wiring 35 can easily be disposed when the optical wiring module is mounted on the electronic device.

The optical receiving unit 37 includes the light receiving element 23 and the amplifier circuit 24. The light receiving element 23 receives the optical signal transmitted through the optical wiring 35, and converts the optical signal into an electric signal. The amplifier circuit 24 amplifies the electric signal output from the light receiving element 23, and outputs the amplified electric signal to the electric wiring unit.

According to the fourth embodiment, the optical wiring is provided in the transmission line of the high-speed signal, which allows the length of the electric wiring unit to be shortened by the length of the optical wiring. Therefore, a transmission loss is reduced and an influence of waveform degradation caused by a parasitic capacitance is also reduced, so that an upper limit of the transmission speed of the electric wiring unit can be enhanced. The optical wiring is smaller than the electric wiring in the transmission loss, and the signal is transmitted without the influence of EMI, so that the transmission speed can be enhanced in the optical wiring compared with the electric wiring. Accordingly, the transmission speed higher than the transmission speed of the electric wiring can be achieved. Accordingly, the transmission speed of the high-speed signal can be enhanced. Additionally, because the EMI is not generated from the optical wiring unit, the intensity of the EMI generated from the transmission line of the high-speed signal can largely reduced by increasing a ratio of the optical wiring to the transmission line of the high-speed signal. Therefore, according to the configuration in FIG. 18(A), the effect of the first embodiment is further enhanced, so that the probability of occurrence of the peak value of the EMI can further be decreased. Similarly, the probability of occurrence of the peak value of the EMI can further be decreased by the configuration in FIG. 18(B).

### Fifth Embodiment

A configuration of a transmission system according to a fifth embodiment is identical to the configuration in FIG. 18(A) or 18(B). Accordingly, the fifth embodiment will be described below with reference to FIGS. 18(A) and 18(B).

In the fifth embodiment, like the second embodiment, the transmission unit 1 transmits the invalid high-speed signal in consideration of the phase synchronization of the PLL 2a included in the receiving unit 2. In the fifth embodiment, a sum period of the transmission period of the invalid signal transmitted from the transmission unit 1 and the delay time of the delay unit (4a and 4b) is determined so as to be longer than a whole rising times of the light emitting element 21 and the driving circuit 22. The “rising time” means a time from when the signal is input to the driving circuit 22 to when the stable signal is transmitted from the light emitting element 21. The time to when the stable signal is transmitted means a time to when an error of the signal from the light emitting element 21 is not generated thereafter.

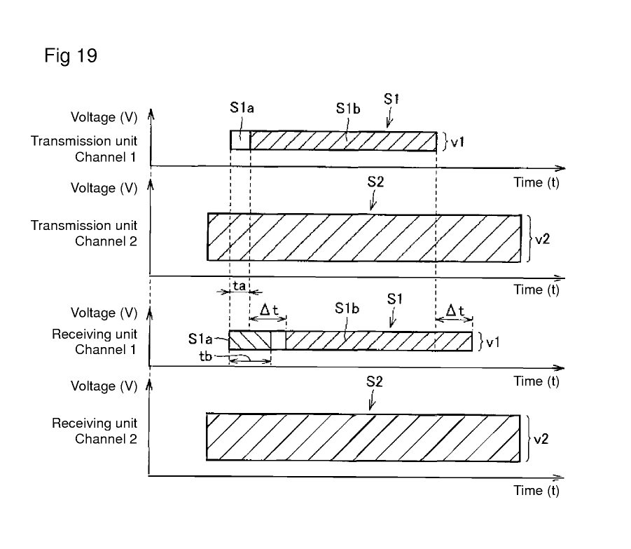

FIG. 19 is a timing chart illustrating the high-speed signal transmission and the low-speed signal transmission, which are performed by the transmission system of the fifth embodiment. Referring to FIG. 19, it is assumed that ta is a transmission time of the invalid signal S1a that is included in the high-speed signal S1 transmitted from the transmission unit 1. It is assumed that tb is the whole rising times of the light emitting element 21 and the driving circuit 22. In the fifth embodiment, a sum period (ta+Δt) of the period ta during which the transmission unit 1 transmits the invalid signal and the delay time Δt of the delay unit (4a and 4b) is prescribed so as to be longer than the rising time tb (ta+Δt>tb).

According to the fifth embodiment, like the first to fourth embodiments, the probability of occurrence of the peak value of the EMI can be decreased. Additionally, according to the fifth embodiment, as illustrated in FIG. 19, the rising time ta of the light emitting element 21 and the driving circuit 22 can also used as part of the period (ta+Δt) during which the receiving unit 2 receives the invalid high-speed signal. Therefore, the time for which the transmission unit 1 transmits the high-speed signal can be shortened, because the period during which the transmission unit 1 transmits the invalid signal can be shortened. According to the fifth embodiment, like the second embodiment, the average power consumption can be reduced during the operation of the transmission system.

### Sixth Embodiment

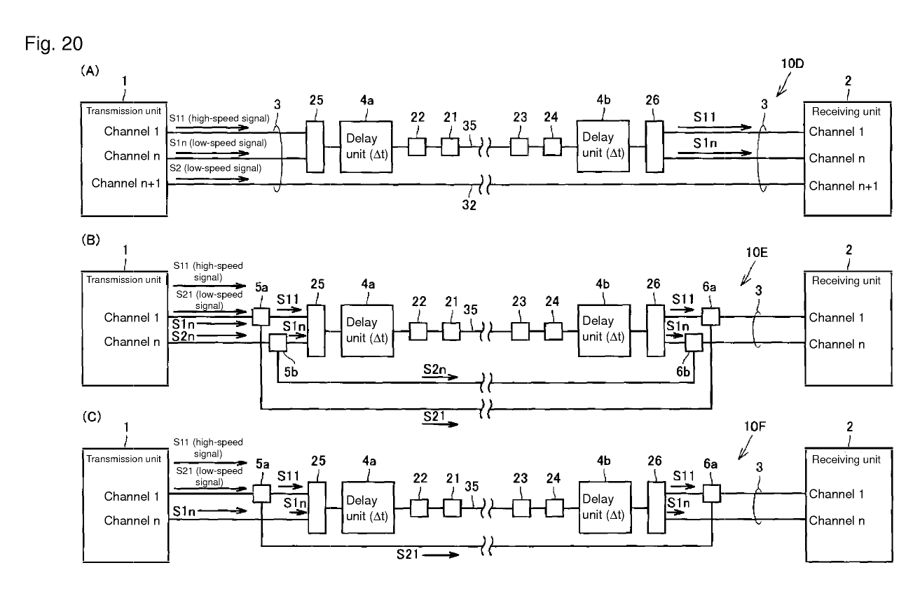

FIGS. 20(A), 20(B) and 20(C) are views illustrating a configuration of a transmission system according to a sixth embodiment. FIG. 20(A) is a view illustrating a first example of the configuration of the transmission system of the sixth embodiment. FIG. 20(B) is a view illustrating a second example of the configuration of the transmission system of the sixth embodiment. FIG. 20(C) is a view illustrating a third example of the configuration of the transmission system of the sixth embodiment.

As illustrated in FIGS. 20(A) to 20(C), the transmission system (10D, 10E, and 10F) of the sixth embodiment has a configuration in which a serializer circuit 25 and a deserializer circuit 26 are added to the configuration of the fourth embodiment. The serializer circuit 25 converts plural high-speed signals (high-speed signals S11 and S1n), which are transmitted in parallel from plural channels (in FIG. 20(A), channels 1 and n) of the transmission unit 1, into a serial high-speed signal. The deserializer circuit 26 converts the serial high-speed signal into parallel high-speed signals (the high-speed signals S11 and S1n). The high-speed signals S11 and S1n are input to plural channels (channels 1 and n) of the receiving unit 2. The low-speed signal S2 is transmitted from the channel n+1 of the transmission unit 1, and input to the channel n+1 of the receiving unit 2 through the transmission line 32.

In the configuration in FIG. 20(A), each of the transmission unit 1 and the receiving unit 2 includes plural channels (the channels 1 to n) through which the high-speed signal is transmitted and one channel (channel n+1) through which the low-speed signal is transmitted. n is integers of 2 or more, and there is no particular limitation to n.

In the configuration in FIG. 20(B), each of the transmission unit 1 and the receiving unit 2 includes at least one channel through which both the high-speed signal and the low-speed signal are transmitted. Accordingly, each of the transmission unit 1 and the receiving unit 2 may have one channel in order to transmit both the high-speed signal and the low-speed signal , and one (for example, the high-speed signal) of the high-speed signal and the low-speed signal may be transmitted through another channel. However, FIG. 20(B) illustrates the configuration in which the both the high-speed signal and the low-speed signal are transmitted through each of the plural channels (the channels 1 to n). According to the configuration in FIG. 20(B), the channel 1 is used to transmit the high-speed signal S11 and the low-speed signal S21, and the channel n is used to transmit the high-speed signal S1n and the low-speed signal S2n.

In order to separate the high-speed signal and the low-speed signal, which are transmitted through the same channel, from each other, the signal separator (5a and 5b) and the signal coupler (6a and 6b) are provided with respect to the channel. The signal separator 5a and the signal coupler 6a are provided with respect to the channel 1, and the signal separator 5b and the signal coupler 6b are provided with respect to the channel n.

According to the configuration in FIG. 20(C), although the signal separator 5a and the signal coupler 6a are provided with respect to the channel 1, the signal separator and the signal coupler are not provided with respect to the channel n. As illustrated in FIG. 20(C), the signal separator and the signal coupler are not necessarily provided with respect to all the channels, but the signal separator and the signal coupler may be eliminated with respect to the channel through which the low-speed signal is not transmitted even in the high amplitude.

The serializer circuit 25, the delay unit 4a, and the driving circuit 22 may integrally be provided. Similarly, the deserializer circuit 26, the delay unit 4b, and the amplifier circuit 24 may integrally be provided. Like the fourth embodiment, the delay unit 4a and the driving circuit 22 may integrally be provided, and the delay unit 4b and the amplifier circuit 24 may integrally be provided. The delay unit may be provided at only one of the preceding position of the driving circuit 22 and the subsequent position of the amplifier circuit 24.

The sixth embodiment has the configuration all the high-speed signals are transmitted through the wiring unit (the optical wiring), and the generation of the EMI can be eliminated in the wiring unit. According to the sixth embodiment, the EMI is reduced to a level lower than that of the fourth embodiment, so that the probability of occurrence of the peak value of the EMI can further be decreased compared with the fourth embodiment.

### Seventh Embodiment

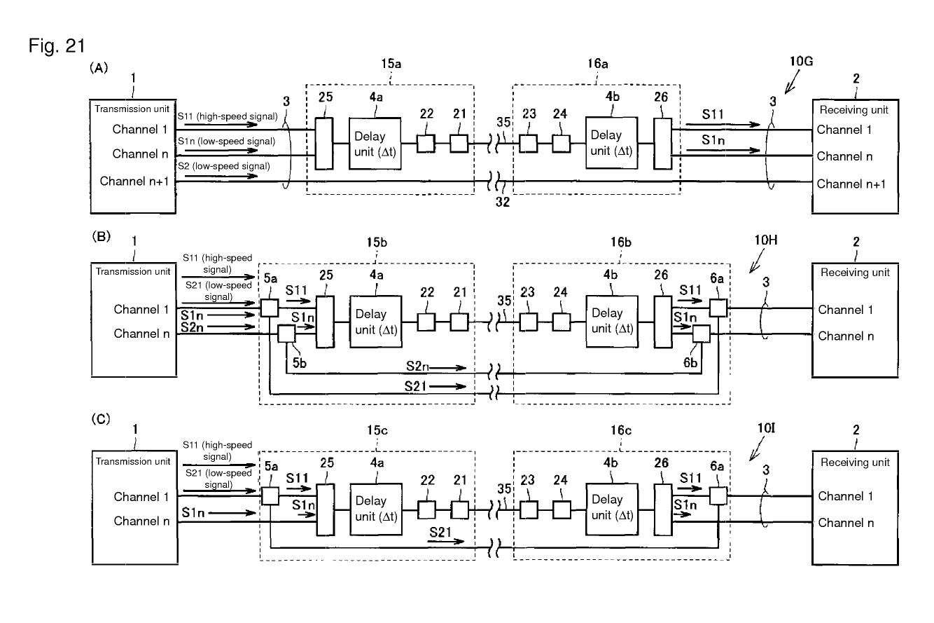

FIGS. 21(A), 21(B) and 21(C) are views illustrating a configuration of a transmission system according to a seventh embodiment. FIG. 21(A) is a view illustrating a first example of the configuration of the transmission system of the seventh embodiment. FIG. 21(B) is a view illustrating a second example of the configuration of the transmission system of the seventh embodiment. FIG. 21(C) is a view illustrating a third example of the configuration of the transmission system of the seventh embodiment.

As illustrated in FIGS. 21(A) to 21(C), the transmission system (10G, 10H, and 101) of the seventh embodiment includes transmission module (15a, 15b, and 15c) and a receiving module (16a, 16b, and 16c). As illustrated in FIG. 21(A), the transmission module 15a includes the light emitting element 21, the driving circuit 22, the serializer circuit 25, and the delay unit 4a. The receiving module 16a includes the light receiving element 23, the amplifier circuit 24, the delay unit 4b, and the deserializer circuit 26.

As illustrated in FIG. 21(B), the transmission module 15b includes the signal separators 5a and 5b in addition to the components of the transmission module 15a. Similarly, the receiving module 16b includes the signal couplers 6a and 6b in addition to the components of the receiving module 16a. Like the sixth embodiment, the number of signal separators and the number of signal couplers depend on the number of channels through which both the high-speed signal and the low-speed signal are transmitted. Accordingly, unlike the configuration in FIG. 21(B), there is no particular limitation to the number of signal separators mounted on the transmission module and the number of signal couplers mounted on the receiving module.

As illustrated in FIG. 21(C), the transmission module 15c differs from the transmission module 15b in that the signal separator 5b included in the transmission module 15b is eliminated. Similarly, the receiving module 16c differs from the receiving module 16b in that the signal coupler 6b included in the receiving module 16b is eliminated. Like the configuration in FIG. 20(C), the signal separator and the signal coupler are not necessarily provided with respect to all the channels, but the signal separator and the signal coupler may be eliminated with respect to the channel through which the low-speed signal is not transmitted even in the high amplitude.

Like the fourth embodiment, the delay unit is not necessarily included in both the transmission module and the receiving module. The delay unit may be included only in one of the transmission module and the receiving module.

When the delay unit is included in at least one of the transmission module and the receiving module, various modifications can be made in the configurations of the transmission modules and the receiving modules in FIGS. 21(A) to 21(C). For example, the transmission module may include the light emitting element 21 and the driving circuit 22, and the serializer circuit 25 (and the signal separator) may be provided outside the transmission module. Similarly, the receiving module may include the light receiving element 23 and the amplifier circuit 24, and the deserializer circuit 26 (and the signal coupler) may be provided outside the receiving module.

Alternatively, the transmission module may include the light emitting element 21, the driving circuit 22, and the serializer circuit 25, and the signal separator may be provided outside the transmission module. Similarly, the receiving module may include the light receiving element 23 and the amplifier circuit 24, and the deserializer circuit 26, and the signal separator may be provided outside the receiving module.

In the configurations in FIGS. 21(A) to 21(C), the light emitting element 21, the driving circuit 22, and the serializer circuit 25 may be mounted on the transmission module while the light receiving element 23 and the amplifier circuit 24 are mounted on the receiving module, and the delay unit may be mounted on at least one of the transmission module and the receiving module.

Similarly, in the configurations in FIGS. 18(A) and 18(B), the light emitting element 21 and the driving circuit 22 may be mounted on the transmission module, and the light receiving element 23 and the amplifier circuit 24 may be mounted on the receiving module. In this case, the delay unit may be included in at least one of the transmission module and the receiving module. In the configuration in FIG. 18(B), the signal separator may further be mounted on the transmission module while the signal coupler is mounted on the receiving module.

According to the seventh embodiment, the same effect as the sixth embodiment can be obtained. Additionally, according to the seventh embodiment, the optical wiring module is constructed by the transmission module, the optical wiring, and the receiving module, the optical wiring module having the delay function can be constructed.

### APPLICATION EXAMPLE OF TRANSMISSION SYSTEM

Various electronic devices can be equipped with the transmission system of an embodiment of the present invention. The electronic device equipped with the transmission system of the first embodiment will be described below as a typical example.

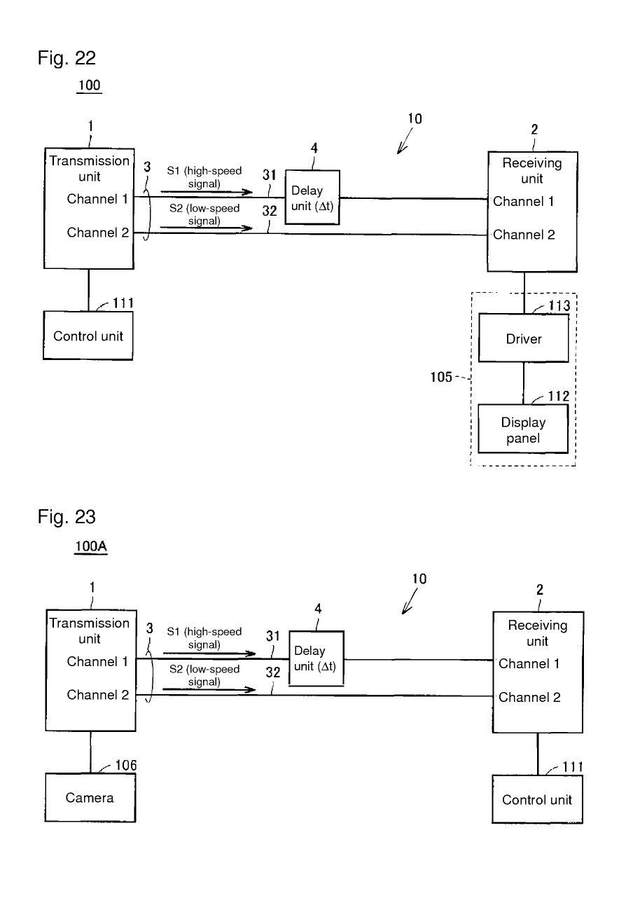

FIG. 22 is a view illustrating a first example of the configuration of an electronic device equipped with the transmission system according to an embodiment of the present invention. Referring to FIG. 22, an electronic device 100 includes the transmission system 10 of an embodiment of the present invention, a control unit 111, and a display device 105. The display device 105 includes a display panel 112 and a driver 113.

The transmission unit 1 transmits the high-speed signal S1 and the low-speed signal S2 to the receiving unit 2 through the transmission line 3. The control unit 111 generates the high-speed signal S1 and the low-speed signal S2, which are transmitted by the transmission unit 1. For example, the control unit 111 is constructed by an MPU (Micro Processing Unit). The high-speed signal S1 includes the image data signal and the clock, and the low-speed signal is the image display synchronous signal (the horizontal synchronous signal (H-sync) or the vertical synchronous signal (V-sync)) and the display refresh timing notification signal.

The receiving unit 2 receives the image data signal and the control signal, which are transmitted from the transmission unit 1, and transfers the image data signal and the control signal to the display device 105. The display device 105 receives the image data signal and the control signal from the receiving unit 2, and displays the image based on the image data signal and the control signal.

The display device 105 includes the display panel 112 that displays a image and the driver 113 that drives the display panel 112. For example, the display device 105 is the liquid crystal display device, and the display panel 112 is the liquid crystal display panel. Alternatively, other kinds of display devices, such as an organic EL (electroluminescence) display, may be applied to the display device 105.

When sensing an error of the image data signal transmitted by the transmission unit 1, the receiving unit 2 may transmit a signal (the signal is the low-speed signal) indicating the error to the transmission unit 1 through the transmission line 32.

In the configuration in FIG. 22, the receiving unit 2 and the driver 113 are separately provided. Alternatively, the receiving unit 2 and the driver 113 may integrally be provided. That is, the driver 113 may have the function of the receiving unit 2. Similarly, the control unit 111 and the transmission unit 1 may be integrally provided.

FIG. 23 is a view illustrating a second example of the configuration of the electronic device equipped with the transmission system of an embodiment of the present invention. Referring to FIG. 23, an electronic device 100A includes the transmission system 10 of an embodiment of the present invention, a camera 106, and the control unit 111.

The transmission unit 1 transmits the image data from the camera 106. The configuration of the electronic device 100A differs from the configuration of the electronic device 100 in FIG. 22 in this point. There is no particular limitation to the kind of the camera 106. For example, a CCD camera and a CMOS camera can be applied to the camera 106.

The transmission unit 1 transmits the image data captured by the camera 106 as the high-speed signal S1, and transmits the control signal as the low-speed signal S2. The receiving unit 2 receives the high-speed signal S1 and the low-speed signal. The control unit 111 generates the image data based on these signals.

Like the electronic device 100, the transmission unit 1 may be included in the camera 106 as a part of the camera 106, and the receiving unit 2 may be included in the control unit 111 as a part of the control unit 111.

In the above operation, the transmission unit 1 is a master and the receiving unit 2 is a slave. That is, the receiving unit 2 passively receives the image data signal and control signal that are transmitted from the transmission unit 1. Alternatively, the receiving unit 2 may act as the master while the transmission unit 1 acts as the slave. That is, the receiving unit 2 may control the transmission unit 1 such that the transmission unit 1 transmits the high-speed signal S1 (the image data signal) and the low-speed signal S2 (the control signal).

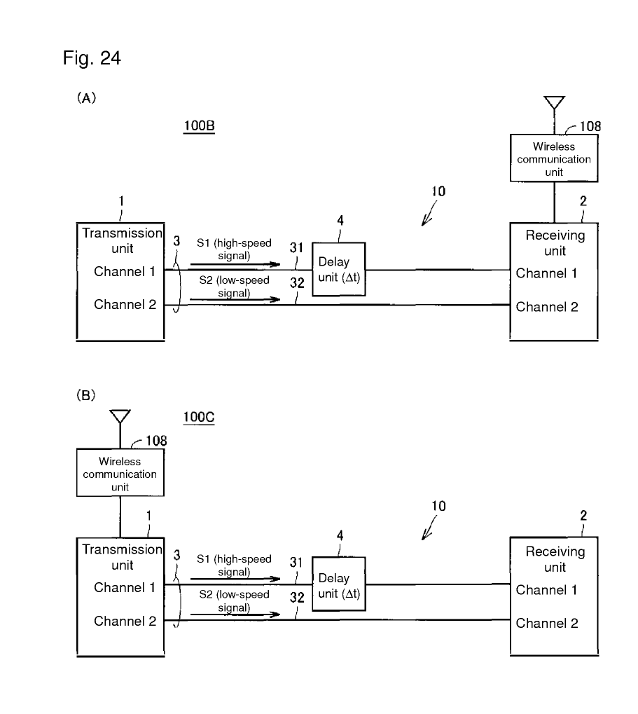

FIG. 24(A) is a view illustrating a third example of the configuration of the electronic device equipped with the transmission system of an embodiment of the present invention. FIG. 24(B) is a view illustrating a fourth example of the configuration of the electronic device equipped with the transmission system of an embodiment of the present invention.

Referring to FIG. 24(A), an electronic device 100B includes the transmission system 10 of an embodiment of the present invention and a wireless communication unit 108. The wireless communication unit 108 obtains the data, which is received from the transmission unit 1 through the data transmission line by the receiving unit 2, from the receiving unit 2, and transmits the data in a form of a radio signal.

A configuration of an electronic device 100C in FIG. 24(B) differs from the configuration in FIG. 24(A) in that the wireless communication unit 108 is connected to the transmission unit 1. In the configuration in FIG. 24(B), the wireless communication unit 108 receives the radio signal transmitted from the outside, and transmits the received radio signal to the transmission unit 1. The transmission unit 1 outputs the signal, which is received from the wireless communication unit 108, as the high-speed signal S1 and the low-speed signal S2 to the receiving unit 2 through the transmission line 3.

### APPLICATION EXAMPLE

There is no particular limitation to the electronic device to which the present invention can be applied. Nowadays, there is a demand for the reduction of the EMI irrespective of the kind of the electronic device. Additionally, there is also a demand for the reduction of the power consumption of the electronic device. When the electronic device is equipped with the transmission system of the invention, the influence of the EMI generated from the electronic device can be reduced while the power consumption of the electronic device is reduced.

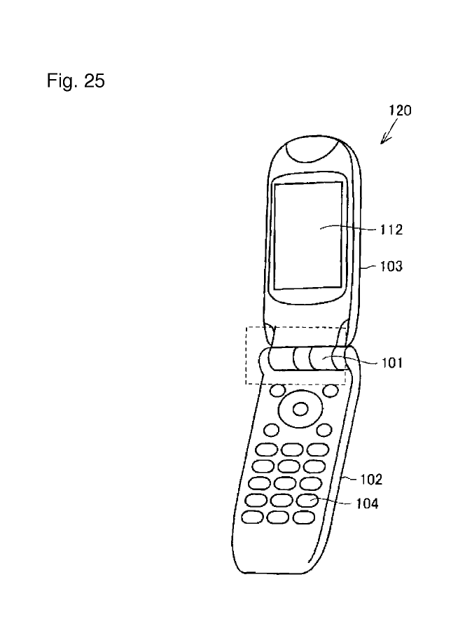

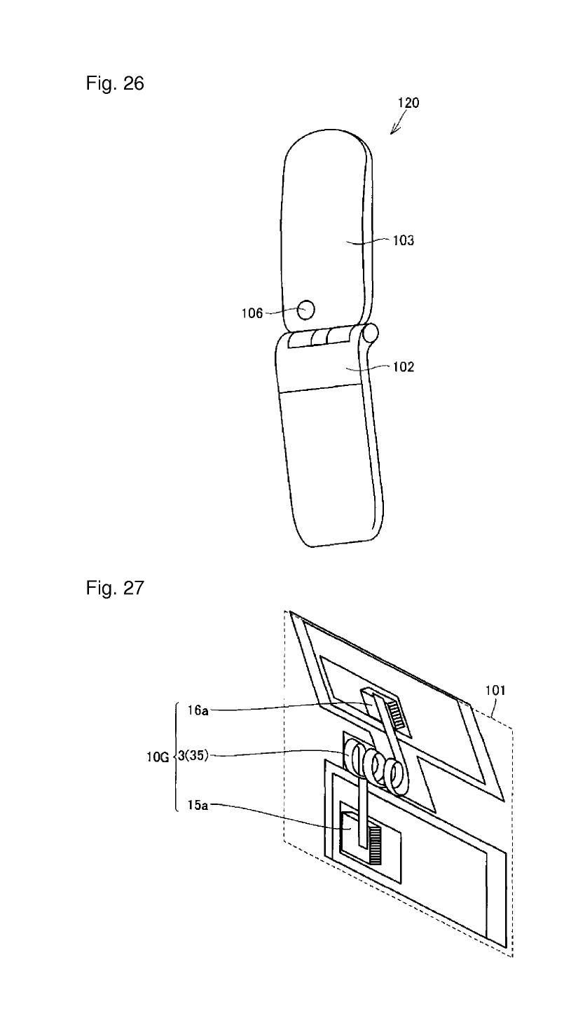

FIG. 25 is a perspective view illustrating a mobile phone that is one of the electronic devices equipped with the transmission system of the present invention when the mobile phone is viewed from a front direction. FIG. 26 is a perspective view illustrating the mobile phone in FIG. 25 when the mobile phone is viewed from a backside direction. Referring to FIGS. 25 and 26, a mobile phone 120 is a folding mobile phone. The mobile phone includes a main body 102, a hinge 101 that is provided at one end of the main body 102, and a cover 103 that is provided so as to be rotatable about the hinge 101. The main body 102 includes a manipulation key 104 for the mobile phone manipulation. The cover 103 includes the display panel 112 and the display panel 112 includes the driver 113. The mobile phone 120 also includes the wireless communication unit 108. The camera 106 is provided in the cover 103. However, there is no particular limitation to the position of the camera 106.

FIG. 27 is a perspective plan view illustrating the hinge 101 in FIG. 25 and a peripheral portion thereof. Referring to FIG. 27, the transmission module 15a (see FIG. 21(A)) is mounted on the main body 102. On the other hand, the receiving module 16a (see FIG. 21(A)) is mounted on the cover 103. The transmission module 15a is connected to the receiving module 16a by the transmission line 3 including the optical wiring 35.

The configuration in FIG. 27 is an example in which the transmission system 10G is applied to the mobile phone 120. Alternatively, instead of the transmission system 10G, the transmission system 10H or 10I may be mounted on the mobile phone 120. In this case, the transmission module 15b and the receiving module 16b in FIG. 21(B) or the transmission module 15c and the receiving module 16c in FIG. 21(C) are applied instead of the transmission module 15a and the receiving module 16a. The mobile phone 120 is not limited to one of the transmission systems 10G to 10I, but the transmission systems (10, and 10A to 10F) of other embodiments of the present invention may be applied to the mobile phone 120.

In the case that the transmission system of an embodiment of the present invention is used to transmit the data to the display device mounted on the mobile phone, the transmission system can be constructed pursuant to the MIPI D-PHY standard.

The transmission system of an embodiment of the present invention can also be applied to transmit the image data to the camera 106. In this case, the transmission system can be constructed pursuant to the MIPI D-PHY standard.

Additionally, the transmission system of an embodiment of the present invention can be applied to transmit the signal, which is wirelessly received from the outside by the mobile phone 120 (the wireless communication unit 108), to the inside of the mobile phone 120, or the transmission system can be applied to transmit the data, which is generated in the mobile phone 120, to the wireless communication unit 108 for the purpose of the wireless transmission.

The embodiments are disclosed only by way of example, and the present invention is not limited to the embodiments. The scope of the present invention is described by not the embodiments but claims, and it is noted that all changes equivalent to claims are included in the present invention.

1. A transmission system comprising:
a transmission unit that transmits a first signal having a first voltage value at a first transmission speed, and transmits a second signal having a second voltage value larger than the first voltage value at a second transmission speed lower than the first transmission speed;
a receiving unit that receives the first and second signals;
a transmission line that is configured to perform serial transmission of the first signal, the first and second signals being transmitted through the transmission line; and
a delay unit that is provided on the transmission line to delay the transmission of the first signal with respect to the second signal.

2. The transmission system according to claim 1, wherein
the first signal transmitted from the transmission unit includes an invalid signal to processing based on the first signal and a valid signal to the processing, and
the delay unit delays the valid signal of the invalid signal and the valid signal.

3. The transmission system according to claim 1, wherein the transmission line comprises:
a first transmission line through which the first and second signals transmitted from the transmission unit are commonly transmitted;
a separator that separates the first and second signals transmitted through the first transmission line;
a coupler that couples the first and second signals separated by the separator;
a second transmission line through which the first and second signals coupled by the coupler are transmitted from the coupler to the receiving unit; and
third and fourth transmission lines that are provided in parallel between the separator and the coupler, the first and second signals being transmitted through the third and fourth transmission lines, respectively, and
the delay unit is provided on the third transmission line.

4. The transmission system according to claim 1, wherein
the transmission line comprises:
a first transmission line through which the first signal is transmitted; and
a second transmission line through which the second signal is transmitted,
the first transmission line includes an optical wiring, and
the transmission system further comprises:
a light emitting element that generates an optical signal transmitted through the optical wiring;
a driving circuit that, in response to the first signal, drives the light emitting element to generate the optical signal in the light emitting element;
a light receiving element that converts the optical signal transmitted through the optical wiring into an electric signal; and
an amplifier circuit that amplifies the electric signal output from the light receiving element,
the light emitting element, the driving circuit, the light receiving element, and the amplifier circuit are provided on the first transmission line, and
the delay unit is provided in at least one of a preceding position of the driving circuit on the first transmission line and a subsequent position of the amplifier circuit on the third transmission line.

5. The transmission system according to claim 3, wherein
the third transmission line includes an optical wiring,
the transmission system further comprises:
a light emitting element that generates an optical signal transmitted through the optical wiring;
a driving circuit that, in response to the first signal, drives the light emitting element to generate the optical signal in the light emitting element;
a light receiving element that converts the optical signal transmitted through the optical wiring into an electric signal; and
an amplifier circuit that amplifies the electric signal output from the light receiving element,
the light emitting element, the driving circuit, the light receiving element, and the amplifier circuit are provided on the third transmission line, and
the delay unit is provided in at least one of a preceding position of the driving circuit on the first transmission line and a subsequent position of the amplifier circuit on the third transmission line.

6. The transmission system according to claim 4, wherein
the first signal transmitted from the transmission unit includes an invalid signal to processing based on the first signal and a valid signal to the processing,
the delay unit delays the valid signal of the invalid signal and the valid signal, and
a sum period of a transmission period of the invalid signal transmitted from the transmission unit and a time for which the valid signal is delayed by the delay unit is set so as to be longer than a rising time from a time when the first signal is input to the driving circuit to a time when the light emitting element starts up.

7. The transmission system according to claim 4, wherein
each of the transmission unit and the receiving unit includes a plurality of channels that transmit a plurality of first signals, and
the transmission system further comprises:
a serializer circuit that converts the plurality of first signals transmitted from the plurality of channels of the transmission unit into a serial signal; and
a deserializer circuit that converts the serial signal into the plurality of first signals received by the plurality of channels of the receiving unit.

8. The transmission system according to claim 4, wherein
the light emitting element and the driving circuit are mounted on a transmission module,
the light receiving element and the amplifier circuit are mounted on a receiving module,
the optical wiring is connected between the transmission module and the receiving module, and
at least one of the transmission module and the receiving module includes the delay unit.

9. The transmission system according to claim 7, wherein
the light emitting element, the driving circuit, and the serializer circuit are mounted on a transmission module,
the light receiving element, the amplifier circuit, and the deserializer circuit are mounted on a receiving module,
the optical wiring is connected between the transmission module and the receiving module, and
at least one of the transmission module and the receiving module includes the delay unit.

10. The transmission system according to claim 5, wherein
each of the transmission unit and the receiving unit includes a plurality of channels that transmit a plurality of first signals, and
the transmission system further includes:
a serializer circuit that converts the plurality of first signals transmitted from the plurality of channels of the transmission unit into a serial signal; and
a deserializer circuit that converts the serial signal into the plurality of first signals received by the plurality of channels of the receiving unit.

11. The transmission system according to claim 5, wherein
the light emitting element and the driving circuit are mounted on a transmission module,
the light receiving element and the amplifier circuit are mounted on a receiving module,
the optical wiring is connected between the transmission module and the receiving module, and
at least one of the transmission module and the receiving module includes the delay unit.

12. The transmission system according to claim 5, wherein
the light emitting element, the driving circuit, and the separator are mounted on a transmission module,
the light receiving element, the amplifier circuit, and the coupler are mounted on a receiving module,
the optical wiring is connected between the transmission module and the receiving module, and
at least one of the transmission module and the receiving module includes the delay unit.

13. The transmission system according to claim 10, wherein
the light emitting element, the driving circuit, and the serializer circuit are mounted on a transmission module,
the light receiving element, the amplifier circuit, and the deserializer circuit are mounted on a receiving module,
the optical wiring is connected between the transmission module and the receiving module, and
at least one of the transmission module and the receiving module includes the delay unit.

14. The transmission system according to claim 10, wherein
the light emitting element, the driving circuit, the separator, and the serializer circuit are mounted on a transmission module,
the light receiving element, the amplifier circuit, the coupler, and the deserializer circuit are mounted on a receiving module,
the optical wiring is connected between the transmission module and the receiving module, and
at least one of the transmission module and the receiving module includes the delay unit.

15. The transmission system according to claim 1, wherein the first signal is an image data signal that is used in display processing performed by a display device, and
the second signal is a control signal that is used to control the display processing performed by the display device.

16. The transmission system according to claim 1, wherein the first signal is an image data signal corresponding to an image captured by a camera.

17. The transmission system according to claim 1, wherein the first signal is a signal including data that is transmitted and received by wireless communication.

18. An electronic device comprising the transmission system according to claim 1.

19. The electronic device according to claim 18, wherein the electronic device is a mobile phone.

20. The transmission system according to claim 5, wherein
the first signal transmitted from the transmission unit includes an invalid signal to processing based on the first signal and a valid signal to the processing,
the delay unit delays the valid signal of the invalid signal and the valid signal, and
a sum period of a transmission period of the invalid signal transmitted from the transmission unit and a time for which the valid signal is delayed by the delay unit is set so as to be longer than a rising time from a time when the first signal is input to the driving circuit to a time when the light emitting element starts up.
